(19) United States
(12) Patent Application Publication
(10) Pub. No.: US 2024/0306000 A1
(43) Pub. Date: Sep. 12, 2024

(54) FRAMEWORK FOR SEMANTIC ENCODING AND DECODING IN A WIRELESS COMMUNICATION NETWORK

(71) Applicant: QUALCOMM Incorporated, San Diego, CA (US)

(72) Inventors: Eren BALEVI, Brooklyn, NY (US); Taesang YOO, San Diego, CA (US); June NAMGOONG, San Diego, CA (US)

(21) Appl. No.: 18/179,953

(22) Filed: Mar. 7, 2023

(51) Int. Cl. H04W 16/18; G06F 40/30

(52) U.S. Cl. CPC H04W 16/18; G06F 40/30

(57) ABSTRACT

Certain aspects of the present disclosure provide techniques for semantic communication. A method for wireless communications includes obtaining, by a semantic encoder, a set of real values for transmission to a receiving device; encoding, by the semantic encoder, the set of real values based on a semantic model and a first dimension of a set of dimensions, wherein each different dimension in the set of dimensions corresponds to a different number of real values to output; outputting an encoded set of real values; outputting the encoded set of real values for transmission to the receiving device over a wireless communication channel; obtaining feedback from the receiving device; and using a second dimension of the set of dimensions based on the feedback.

### BACKGROUND

### Field of the Disclosure

Aspects of the present disclosure relate to wireless communications, and more particularly, to techniques for semantic communications in a wireless communication network.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications. The method includes obtaining, by a semantic encoder, a set of real values for transmission to a receiving device. The method includes encoding, by the semantic encoder, the set of real values based on a semantic model and a first dimension of a set of dimensions. Each different dimension in the set of dimensions corresponds to a different number of real values to output. The method includes outputting an encoded set of real values; outputting the encoded set of real values for transmission to the receiving device over a wireless communication channel. The method includes obtaining feedback from the receiving device. The method includes using a second dimension of the set of dimensions based on the feedback.

Another aspect provides a method for wireless communications. The method includes obtaining, from a transmitting device, a first encoded set of real values having a first dimension of a set of dimensions. Each different dimension in the set of dimensions corresponds to a different number of real values of the set of real values. The method includes decoding, by a semantic decoder, the first encoded set of real values based on a semantic model. The method includes attempting to infer a set of real values; outputting feedback to the transmitting device. The method includes obtaining, from the transmitting device, a second encoded set of real values having a second dimension of the set of dimensions in response to the feedback.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example physical (PHY) layer and medium access control (MAC) layer in a wireless communications network.

FIG. 6 depicts an example abstraction of the PHY layer and MAC layer as a pass-fail bit pipe.

FIG. 7 depicts abstraction of the PHY layer and MAC layer as a vector additive white Gaussian noise (AWGN) channel.

FIG. 8 depicts a method for wireless communications.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for semantic communication.

In communication theory, three communication problems/goals are how accurately symbols of communication are transmitted (Level A); how precisely the transmitted symbols convey the desired meaning (Level B); and how effectively the received meaning affects conduct in the desired way (Level B).

Level A is sometimes referred to as the “technical” problem for digital communications. Solutions involve the transmission of a finite set of discrete symbols, well-defined metrics for the accuracy of the symbols, and a communication system for implementing the transmission and reception of the symbols. Level B is sometimes referred as the “semantic” problem. The semantic problem involves the interpretation of meaning at the receiver as compared with the intended meaning of the sender. Level C is sometimes referred to the “effectiveness” problem. The effectiveness problem involves how effectively the received meaning affects conduct in the desired away.

In recent years, wireless communication technology has developed rapidly, bringing great convenience to human life. 5G wireless communication technology has played an important role in smart cities, autonomous driving, telemedicine, and other fields. However, with the gradual increase in the communication rate, the explosive growth of data has created enormous challenges for wireless communication technology. According to a forecast from the International Telecommunication Union (ITU), the annual growth rate of the global mobile data stream will reach up to 55% by 2030.

Much of the advancements in wireless communication have been directed to the Level A technical problem. However, the transmission rate of existing communication technologies has gradually approached the Shannon capacity, which cannot meet the continuously growing communication demands. For example, 6G communication system may play an important role in remote holograph, digital twin, and other application fields needing ultra-high peak rate, ultra-large user experience rate, and ultra-low network latency, which will consume more limited available spectrum and power.

On the other hand, the rapid development of neural networks and artificial intelligence technology promotes the progress of technical research in semantic communication. Traditional wireless communication, under the Shannon paradigm, seeks to guarantee the correct reception of each transmitted packet regardless of its meaning. Semantic communication, however, does not emphasize the perfect recovery of the transmitted message, but is concerned with the problem of how transmitted symbols convey a desired meaning (or semantic) to the destination, as well as how effectively the received meaning affects the action in a desired way. Semantic communication aims to reduce the uncertainty of message understanding between the transmitter and the receiver.

Aspects of the present disclose provide techniques and apparatus for semantic communication in a wireless communication system. In some aspects, a semantic encoder and semantic decoder are provided.

In some aspects, the semantic encoder and semantic decoder may be referred as semantic model. The semantic model may use machine learning (ML), deep learning, artificial intelligence or other techniques to encode information at the semantic encoder side and to extract (e.g., infer or predict) meaning from the transmitted information. In some aspects, the semantic encoder and semantic decoder are jointly trained. In some aspects, the semantic model is trained based on an abstraction of a PHY/MAC channel in between the semantic encoder and semantic decoder as a vector Gaussian AWGN channel. In some aspects, the semantic model is further trained based on target-specific training data, target-specific perceptual loss, a configuration of a semantic-encoding transmitting device, a configuration of a semantic-decoding receiving device, and/or target-specific applications.

In some aspects, a transmitting device generates a set of real-value symbols with the semantic encoder and performs analog coding of the real-value symbols to output a continuous analog signal. In some aspects, a receiving device performs analog decoding of the receiving analog signal to obtain a set of real-value symbols and uses the semantic decoder to predict meaning from the symbols.

In some aspects, the semantic encoder and/or semantic decoder perform semantic rate adaptation. For example, the semantic encoder may perform semantic encoding according to a first dimension of a set of dimensions, receive feedback from the receiving device, and select a different dimension to adapt the semantic rate.

In some aspects, the semantic encoder and/or the semantic encoder may receive or be configured with a priori information for performing the semantic encoding or semantic decoding.

Use of semantic communication in a wireless communication network may reduce data traffic which saves resources, decreases communication delay, and reduced energy consumption. For example, a semantic encoder may perform best-effort lossy delivery of semantic information by filtering out irrelevant, or less important, information. The semantic encoder may transmit semantic-relevant information, which greatly reduces the amount of redundant data transmitted.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

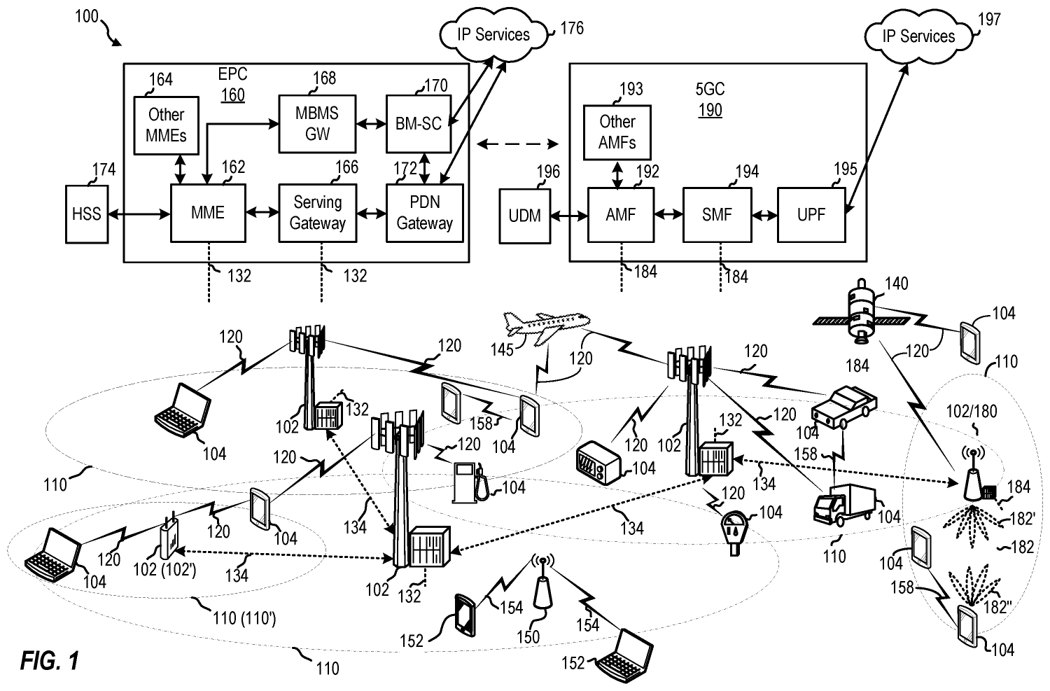

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

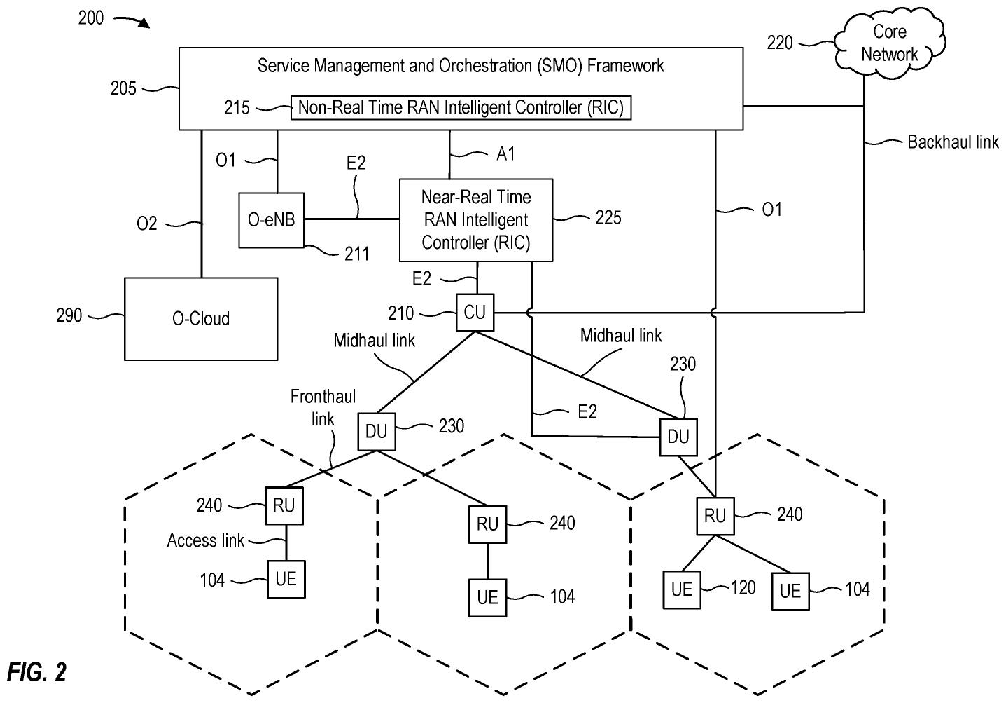

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

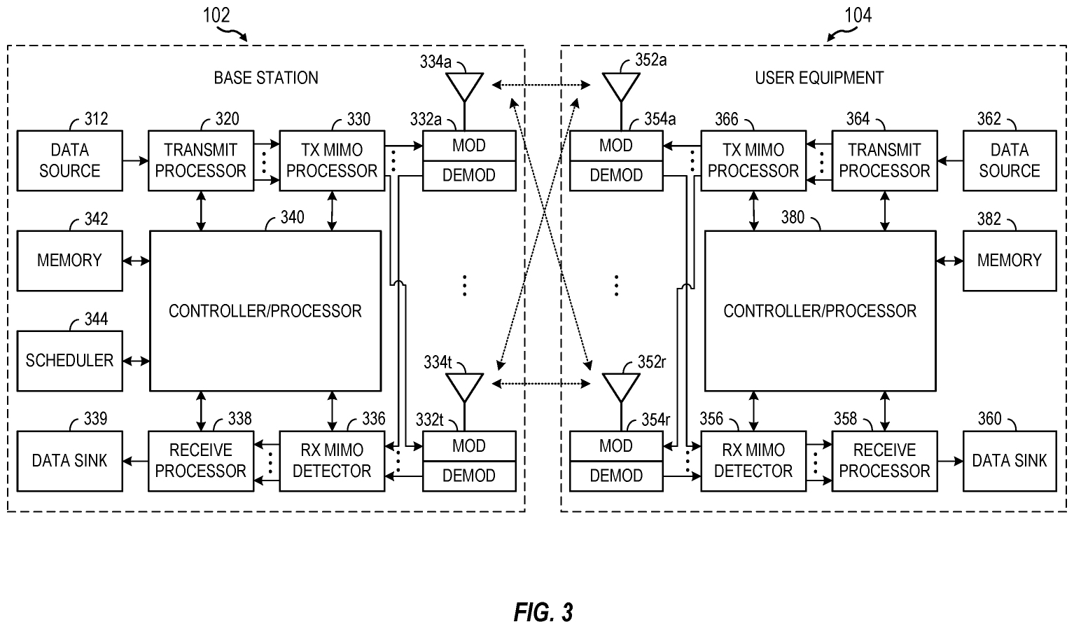

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

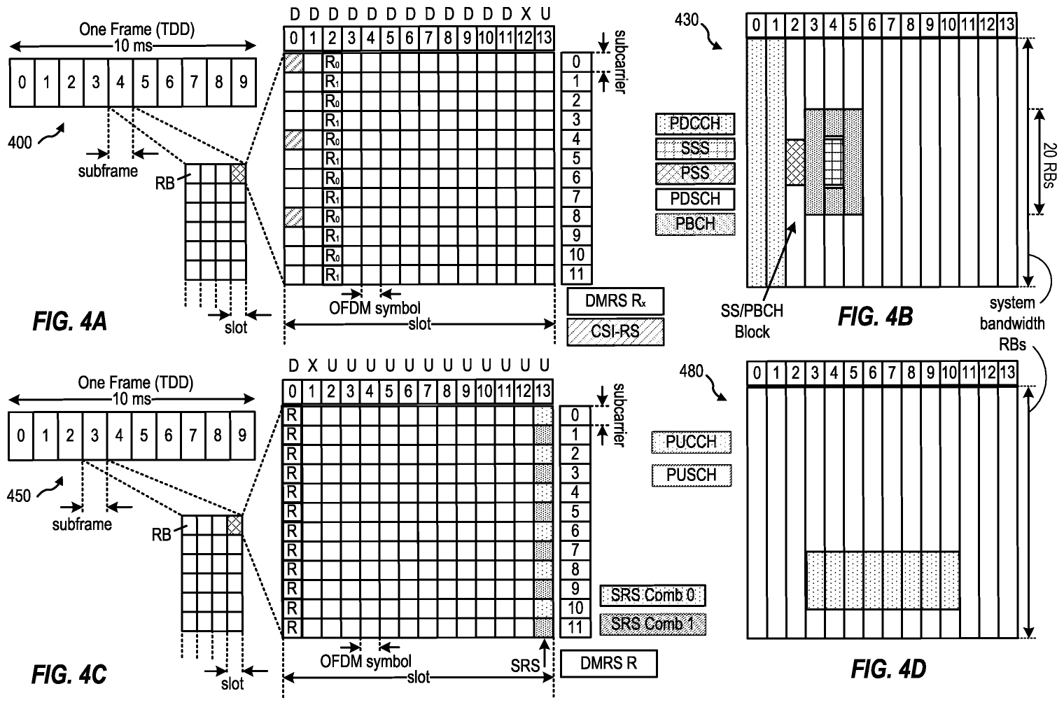

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Semantic Communication

Aspects of the present disclose provide for semantic communication in a wireless communication network. According to certain aspects, semantic communication is natively supported by devices in the wireless communication network.

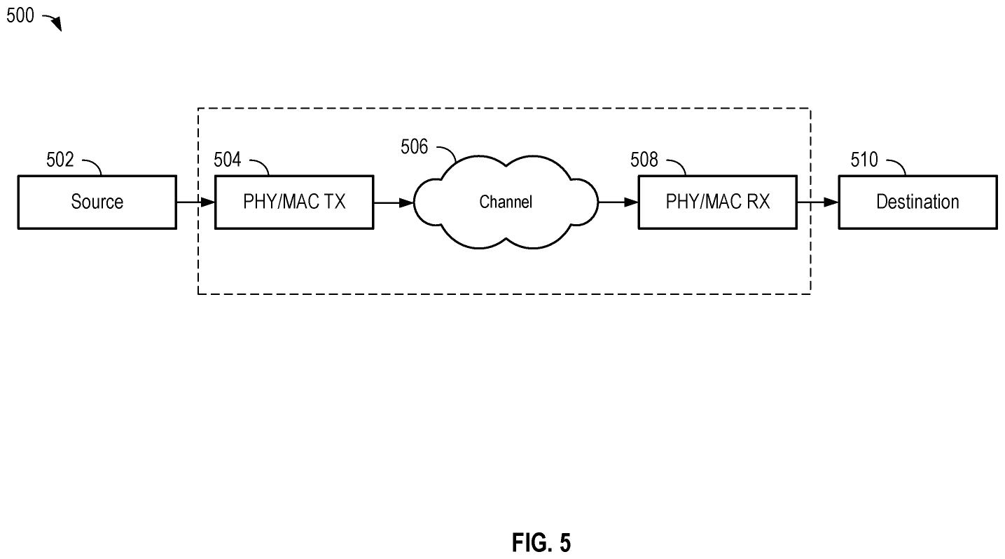

FIG. 5 depicts a source 502 (e.g., a transmitting device, such as a BS 102 on a downlink or a UE 104 on an uplink or a sidelink) and a destination 510 (e.g., a receiving device, such as a BS 102 on an uplink or a UE 104 on a downlink or a sidelink) in a wireless communication network 500 (e.g., such as wireless communication network 100). Signals are transmitted from the source 502 to the destination 510 over the wireless channel 506 through the physical (PHY) layer and the medium access control (MAC) layer at the source side (PHY/MAC TX 504) and the PHY/MAC layer at the destination side (PHY/MAC RX 508).

The PHY layer is responsible for establishing the physical link between the source 502 and destination 510. The PHY layer may perform modulation, channel coding, multiple access, beamforming, and/or interference management. Modulation is the process of converting digital data into analog signals that can be transmitted wirelessly. The PHY layer in 5G uses advanced modulation techniques such as QAM and OFDM to achieve higher data rates and better spectral efficiency. Channel coding is the process of adding redundant information to the data before transmission to protect against channel errors. The PHY layer in 5G uses advanced error-correcting codes such as low-density parity-check (LDPC) codes and Polar codes, which provide improved performance in challenging wireless channel conditions. Multiple access techniques allow multiple users to share the same wireless channel. The PHY layer in 5G uses two main techniques for multiple access—OFDMA and SC-FDMA. These techniques enable efficient sharing of wireless resources and support a large number of devices. Beamforming is a technique used to improve the signal strength and quality at the receiver end. Beamforming is achieved by focusing the transmission in a specific direction towards the receiver. The PHY layer in 5G uses advanced beamforming techniques such as Massive MIMO and mmWave beamforming, which provide high-speed data transfer rates and better signal quality. The PHY layer may use advanced techniques such as interference cancellation, interference alignment, and dynamic spectrum sharing to mitigate interference and improve system performance.

The MAC layer is responsible for managing access to the wireless medium, coordinating communication between devices, and ensuring the efficient use of network resources. The MAC layer may be responsible for error detection, flow control, rules and protocols that determine how devices can transmit and receive data, and the allocation of resources. In 5G networks, the MAC layer may support advanced scheduling technique to allocate resources dynamically based on the current demand and the quality of service requirements of the applications running on the devices. The MAC layer may also support multiple access techniques, such as time division multiple access (TDMA) and frequency division multiple access (FDMA), which allow multiple devices to share the same wireless medium.

The channel 506 is the physical medium through which electromagnetic waves (e.g., wireless signals) propagate between the source 502 and the destination 510.

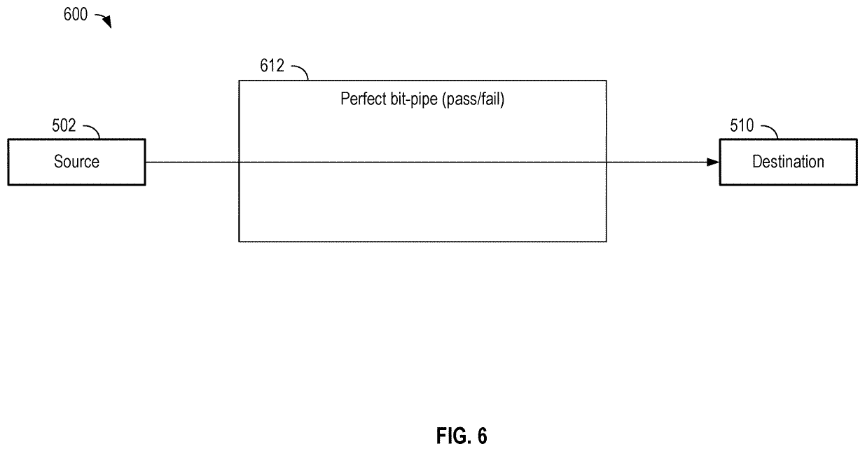

As discussed above, conventionally, the PHY/MAC layers 504 and 508 and channel 506 are treated as a bit-pipe 612, as shown in FIG. 6, over which bits transmitted between source 502 and destination 510 may pass or fail, and which strives for error-free delivery of the bits.

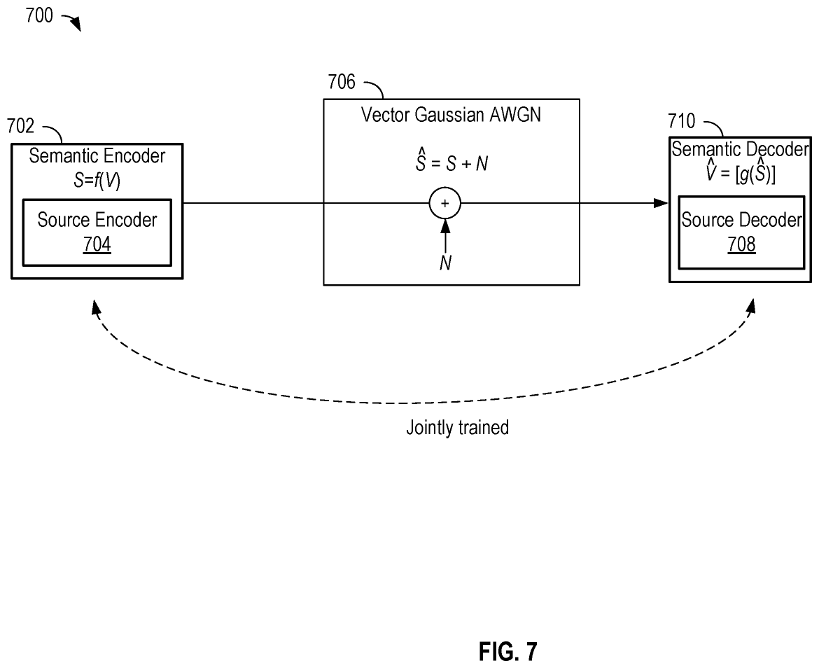

According to aspects of the present disclosure, the PHY/MAC layers 504 and 508 and channel 506 are abstracted as a vector Gaussian additive white Gaussian noise (AWGN) channel 706, as shown in FIG. 7. The AWGN channel 706 models the noise that is added to a signal as it is transmitted over a communication channel. The term “white” in AWGN refers to the fact that the noise has a constant power spectral density across all frequencies, which means that the noise is equally strong across all frequencies. The term “additive” refers to the fact that the noise is added to the transmitted signal, rather than being a part of the signal itself. The noise in an AWGN channel is usually modeled as a Gaussian random variable, which means that the noise values are distributed according to a Gaussian or normal distribution. The AWGN noise may contain independent and identically distributed (IID) elements.

With the PHY/MAC layers 504 and 508 and channel 506 abstracted as a vector Gaussian AWGN channel 706, a semantic encoder 702 and semantic decoder 710 may be trained with a semantic model for semantic communication in a wireless communication system.

In some aspects, the semantic encoder 702 and semantic decoder 710 are jointly trained. In some aspects, the semantic encoder 702 and semantic decoder 710 are separately trained.

In some aspects, a semantic model for the semantic encoder 702 and semantic decoder 710 is trained offline and the semantic encoder 702 and semantic decoder 710 are configured with the semantic model. In some aspects, a semantic model for the semantic encoder 702 and semantic decoder 710 is trained or fine-tuned during run-time or may learn and adapt and be updated during run-time.

In some aspects, the semantic model for the semantic encoder 702 and semantic decoder 710 may be designed via using machine learning, artificial intelligence, deep learning, a neural network, knowledge graph, or a combination of techniques.

In some aspects, the semantic encoder 702 and semantic decoder 710 are trained based on the AWGN channel 706, target-specific training data, target-specific perceptual loss, a configuration of the transmitter, a configuration of the receiver, or a combination.

Target-specific training data and target-specific perceptual loss may vary based on the application, the transmitter, and/or the receiver. Examples of applications include, but not are not limited to, question-answer applications, object detection applications, object classification applications, large language learning model applications, or other applications.

Perceptual loss, also known as content loss or feature loss, is a loss function used in deep learning and neural network applications (e.g., for image and video processing). Perceptual loss measures the perceptual difference between two images, such as a generated image and a target image, by comparing the high-level features or content of the images rather than the pixel-level differences. Perceptual loss is motivated by the fact that the high-level features of an image, such as the presence of certain objects or textures, are often more important to human perception than the exact pixel values. For example, two images can have different pixel values but the same semantic content, such as a picture of a cat in different lighting conditions. Perceptual loss attempts to capture this high-level content by using pre-trained neural networks trained to extract useful feature representations from images.

In some examples, perceptual loss is measured using a convolutional neural network (CNN) trained on a large dataset of images for image classification. The idea is to use the feature maps of the CNN as a measure of the content of the images. The output of a convolutional layer in the CNN may be used as the feature representation of the images and feature maps of this layer may provide a high-level representation of the image content, where each channel represents a different feature or pattern in the image, such as edges, textures, or objects. To compute the perceptual loss between a generated image and a target image, the feature maps of the CNN may be extracted for both images. Then, the mean squared error (MSE) between the feature maps can be computed to measure the difference in the high-level content between the images. The perceptual loss is then defined as the sum of the MSEs over all the feature maps.

In some aspects, the semantic model uses a knowledge base (KB) or knowledge graph (KG) to represent semantics. The KB or KG is a structured database that stores information and knowledge about a particular domain. It can be thought of as a collection of entities, concepts, and relationships between them. In some example, the basic structure of the knowledge graph is a triplet in the form of an “entity-relation-entity”. From the linguistic point of view, a single entity may have multiple types of semantic information. The specific semantic information can be determined after a relationship is formed between entities, so the triplet in the knowledge graph can be regarded as the smallest semantic symbol. At the core of a KB or KG is the ontology or schema, which defines the concepts and relationships within the domain. Ontologies can be created manually by experts in the domain, or automatically generated through machine learning or natural language processing techniques. Entities in the knowledge base or graph are represented as nodes, which can be linked together by relationships or edges. For example, in a knowledge graph about movies, the entity “Star Wars: A New Hope” would be represented as a node, and would be connected to other nodes representing actors, directors, genres, and other related concepts through various relationships. In addition to representing entities and relationships, a knowledge graph can also store attributes or properties about entities. For example, the entity “Star Wars: A New Hope” might have properties like “release year” and “runtime.”

In some aspects, the semantic encoder 702 performs an analog encoding of real-valued symbols. Analog coding refers to the process of converting an analog signal, which is a continuous-time signal that can take any value within a range, into another analog signal that is more suitable for transmission over a communication channel. Digital channel coding involves the use of digital techniques to encode data so that the data can be transmitted reliably over a noisy communication channel. In digital channel coding, the data to be transmitted may be first converted into a sequence of binary digits (bits), and then encoded using error-correcting codes. These error codes introduce redundancy into the data stream, allowing errors introduced by the channel to be detected and corrected at the receiver.

In some aspects, as shown in FIG. 7, the transmitting side may also include source encoder 704 and the receiving side may include a source decoder 708. In some aspects, the source encoder 704 is implemented together with the semantic encoder 702 and the source decoder 708 is implemented together with the semantic decoder 710, as shown in FIG. 7. In some aspects, the source encoder 704 and the source decoder 708 are implemented separately from the semantic encoder 702 and the semantic decoder 710. In some aspects, the source encoder 704 and/or the source decoder 708 are implemented as part of the PHY/MAC layer.

According to certain aspects, for the semantic encoding, input information V′, the semantic encoder 702 generates a set of real values, the signal vector S, based on a function ƒ(S=ƒ(V) as shown in FIG. 7). The AWGN channel 706 adds the Gaussian noise N to the set of real values S and outputs the signal Ŝ (Ŝ=S+N as shown in FIG. 7), where N˜N (0, σ²I), and where σ² mimics a noise power spectral density (N₀/2).

According to certain aspects, for the analog coding, the signal vector S generated by the semantic encoder 702 includes K real-valued symbols [s₀, . . . , S_{K-1}]. The real-valued symbols [s₀, . . . , S_{K-1}] can then be encoded as N real-values code symbols, C=[c₀, . . . , C_{N-1}], for mapping to resource elements for transmission. In some aspects, the channel coding is designed such that the K dimension vectors experience additive Gaussian noise assumed during the semantic encoding.

According to certain aspects, for the semantic decoding, the semantic decoder 710 obtains information \hat{V}, from the received signal S, based on a function \hat{V}=g(Ŝ) as shown in FIG. 7). The PHY/MAC RX layers decode the signal Ŝ to obtain the real valued symbols.

According to certain aspects, semantic encoder 702 and semantic decoder 710 are configured for semantic rate adaptation. The vector S may be transmitted with a first dimension K of a set of dimensions (K₁, K₁, K₃ . . . ) associated with a first semantic rate. The dimension of a vector may refers to the number of entries it has. In the case of a vector of real values, the dimension refers to the number of real numbers that make up the vector. For example, a vector with only one real number is a one-dimensional vector and a vector with five real numbers is a five-dimensional vector.

In some aspects, the set of dimensions is agreed between the PHY/MAC layers and the semantic layer. The dimension used by the semantic encoder 702 and/or the semantic decoder 710 may be adapted. For example, based on the feedback from the receiving device, the semantic encoder 702 may select a different dimension from the set of dimensions. In some aspects, the receiving device may provide feedback to the transmitting device that the receiving device cannot infer the information from the received signal. In some aspects, the transmitting device receives feedback from the PHY/MAC layers about the quality of the channel. Based on the feedback, the transmitting device may increase the dimension, allowing more real-valued symbols to be transmitted. A smaller dimension corresponds to more compression of the information and a higher semantic rate. A larger dimension corresponds to less compression of the information and a lower semantic rate.

In some aspects, when the channel quality is good, the transmitted information and the inferred information convey the same semantics. When the channel quality is poor, the real-valued symbols may not be transmitted correctly.

In some aspects, semantic-aware scheduling may be performed.

In some aspects, the transmitting device and/or the receiving device has side information for the semantic communication. In some aspects, the side information is a priori information at the device that enables the semantic encoder 702 to perform semantic encoding and/or semantic rate adaptation, the semantic decoder 710 to perform semantic decoding and/or semantic rate adaptation, or both. In some aspects, both the transmitting device and the receiving device have the side information. In some aspects, only the transmitting device has the side information and the receiving device only has a distribution. In some aspects, the a priori information includes information about the output vector S that is used for the input vector V. In some aspects, the side information is received periodically. In some aspects, the side information is received aperiodically.

In some aspects, feedback signaling from the receiving device is obtained at the transmitting device. In some aspects, the feedback signaling may be uplink, downlink, or sidelink control signaling.

In some aspects, the transmitting device and/or the receiving device are configured for the semantic communication by the network. In some aspects, the transmitting device and/or receiving device are configured with the semantic model, the set of dimensions, a dimension from the set of dimensions to use, semantic-aware scheduling, the a priori side information, a configuration for the analog channel coding, or a combination thereof. In some aspects, the transmitting device and/or the receiving device are configured dynamically (e.g., via DCI, MAC CE, or a combination thereof). In some aspects, the transmitting device and/or the receiving device are configured semi-statically (e.g., via RRC, MAC CE, or a combination thereof).

### Example Operations

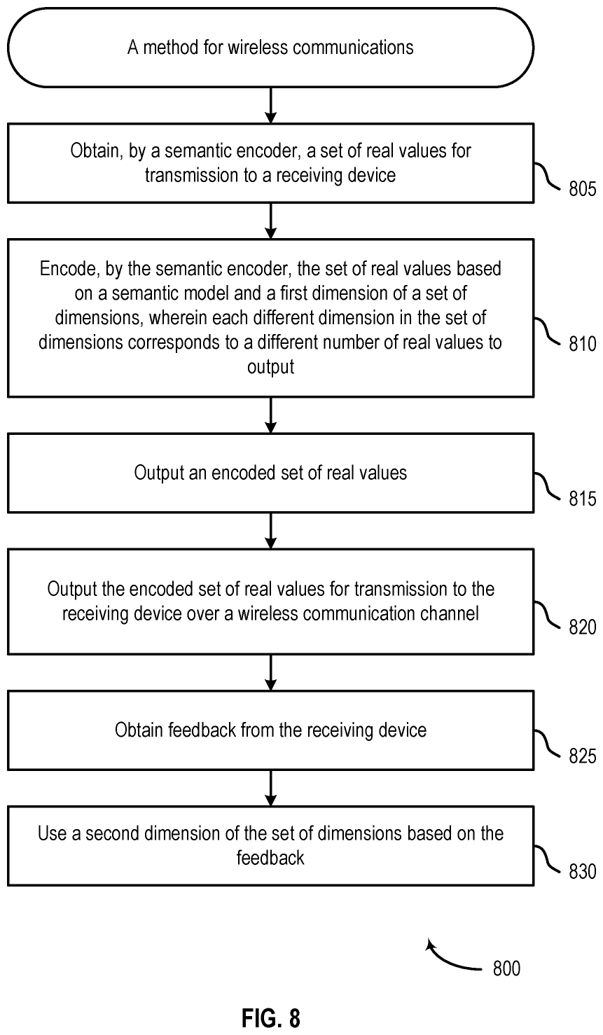

FIG. 8 shows an example of a method 800 of wireless communication at a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

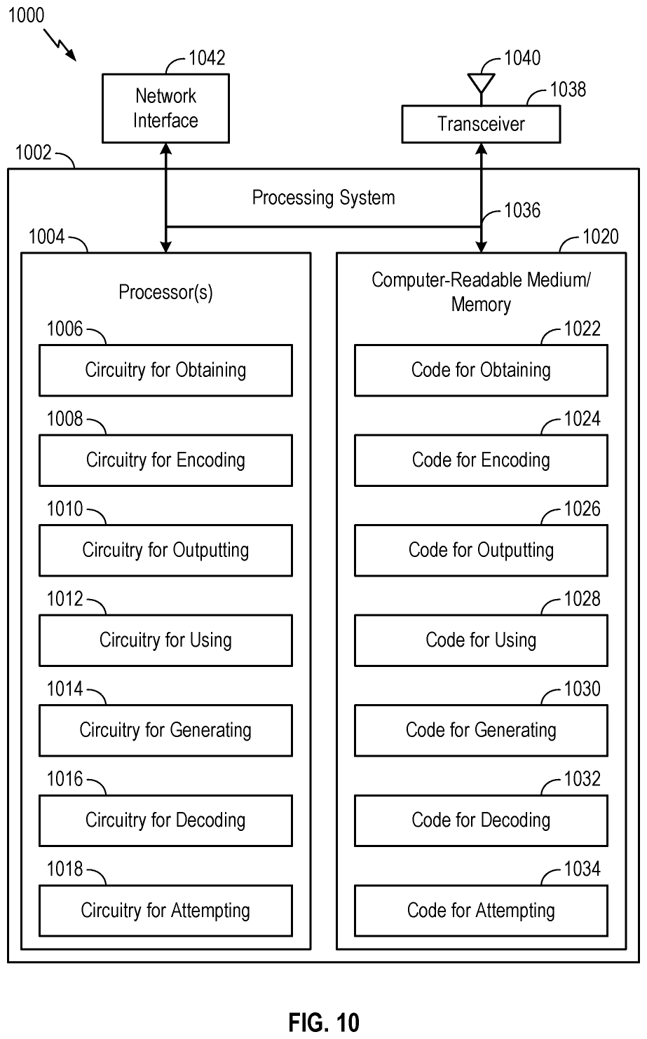

Method 800 begins at step 805 with obtaining, by a semantic encoder, a set of real values for transmission to a receiving device. In some cases, the operations of this step refer to, or may be performed by, circuitry for obtaining and/or code for obtaining as described with reference to FIG. 10.

Method 800 then proceeds to step 810 with encoding, by the semantic encoder, the set of real values based on a semantic model and a first dimension of a set of dimensions, wherein each different dimension in the set of dimensions corresponds to a different number of real values to output. In some cases, the operations of this step refer to, or may be performed by, circuitry for encoding and/or code for encoding as described with reference to FIG. 10.

Method 800 then proceeds to step 815 with outputting an encoded set of real values. In some cases, the operations of this step refer to, or may be performed by, circuitry for outputting and/or code for outputting as described with reference to FIG. 10.

Method 800 then proceeds to step 820 with outputting the encoded set of real values for transmission to the receiving device over a wireless communication channel. In some cases, the operations of this step refer to, or may be performed by, circuitry for outputting and/or code for outputting as described with reference to FIG. 10.

Method 800 then proceeds to step 825 with obtaining feedback from the receiving device. In some cases, the operations of this step refer to, or may be performed by, circuitry for obtaining and/or code for obtaining as described with reference to FIG. 10.

Method 800 then proceeds to step 830 with using a second dimension of the set of dimensions based on the feedback. In some cases, the operations of this step refer to, or may be performed by, circuitry for using and/or code for using as described with reference to FIG. 10.

In some aspects, the semantic model is trained based on a model of the wireless communication channel abstracted as an AWGN channel on top of an existing PHY layer and a MAC layer.

In some aspects, the semantic model is trained based on one or more target specific perceptual loss values.

In some aspects, the target specific perceptual loss values are based on an application or a downstream task associated with the wireless communication, a configuration of the apparatus, a configuration of the receiving device, or a combination thereof.

In some aspects, the semantic model is trained based on target specific training data.

In some aspects, the target specific training data is based on an application or a downstream task associated with the wireless communication, a configuration of the apparatus, a configuration of the receiving device, or a combination thereof.

In some aspects, the semantic model for the semantic encoder is jointly trained with a semantic model for a semantic decoder at the receiving device.

In some aspects, the semantic encoder comprises a neural network.

In some aspects, the output encoded set of real values comprises an analog waveform.

In some aspects, the method 800 further includes obtaining, by a source encoder, the encoded set of real values. In some cases, the operations of this step refer to, or may be performed by, circuitry for obtaining and/or code for obtaining as described with reference to FIG. 10.

In some aspects, the method 800 further includes generating a set of coded symbols based on a third dimension, wherein: generating the set of coded symbols comprises mapping the encoded set of real values to a set of resource elements; and outputting the encoded set of real values for transmission to the receiving device over a wireless communication channel comprises outputting the set of coded symbols for transmission on the set of resource elements. In some cases, the operations of this step refer to, or may be performed by, circuitry for generating and/or code for generating as described with reference to FIG. 10.

In some aspects, the semantic encoder is configured with a priori information, and wherein the semantic encoder is configured to encode the set of real values further based on the a priori information.

In some aspects, the semantic encoder is configured on a UE or a BS.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

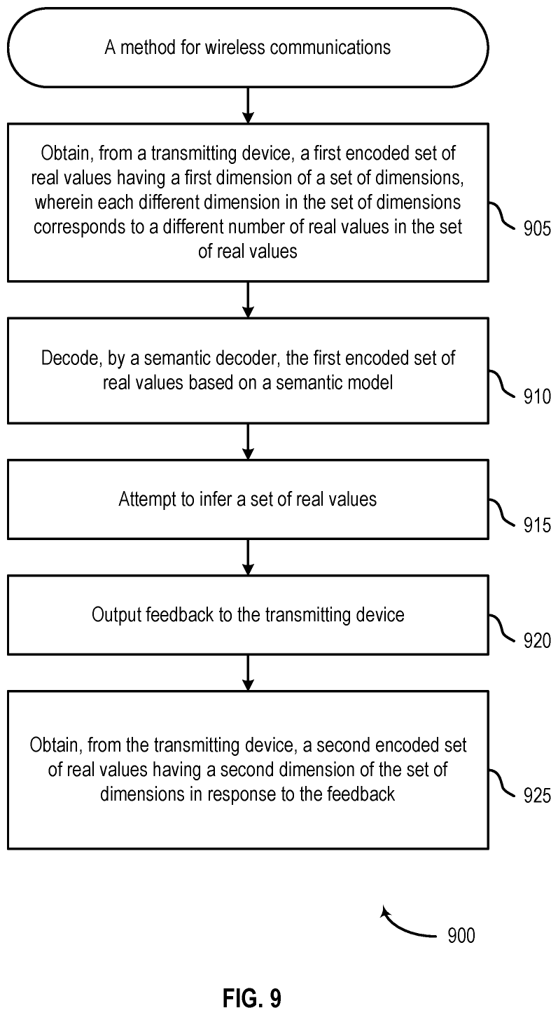

FIG. 9 shows an example of a method 900 of wireless communication at a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

Method 900 begins at step 905 with obtaining, from a transmitting device, a first encoded set of real values having a first dimension of a set of dimensions, wherein each different dimension in the set of dimensions corresponds to a different number of real values of the set of real values. In some cases, the operations of this step refer to, or may be performed by, circuitry for obtaining and/or code for obtaining as described with reference to FIG. 10.

Method 900 then proceeds to step 910 with decoding, by a semantic decoder, the first encoded set of real values based on a semantic model. In some cases, the operations of this step refer to, or may be performed by, circuitry for decoding and/or code for decoding as described with reference to FIG. 10.

Method 900 then proceeds to step 915 with attempting to infer a set of real values. In some cases, the operations of this step refer to, or may be performed by, circuitry for attempting and/or code for attempting as described with reference to FIG. 10.

Method 900 then proceeds to step 920 with outputting feedback to the transmitting device. In some cases, the operations of this step refer to, or may be performed by, circuitry for outputting and/or code for outputting as described with reference to FIG. 10.

Method 900 then proceeds to step 925 with obtaining, from the transmitting device, a second encoded set of real values having a second dimension of the set of dimensions in response to the feedback. In some cases, the operations of this step refer to, or may be performed by, circuitry for obtaining and/or code for obtaining as described with reference to FIG. 10.

In some aspects, the semantic model is trained based on a model of the wireless communication channel abstracted as an AWGN channel on top of an existing PHY layer and a MAC layer.

In some aspects, the semantic model is trained based on one or more target specific perceptual loss values.

In some aspects, the target specific perceptual loss values are based on an application or a downstream task associated with the wireless communication, a configuration of the apparatus, a configuration of the receiving device, or a combination thereof.

In some aspects, the semantic model is trained based on target specific training data.

In some aspects, the target specific training data is based on an application or a downstream task associated with the wireless communication, a configuration of the apparatus, a configuration of the receiving device, or a combination thereof.

In some aspects, the semantic model for the semantic decoder is jointly trained with a semantic model for a semantic encoder at the transmitting device.

In some aspects, the semantic decoder comprises a neural network.

In some aspects, the first encoded set of real values comprises an analog waveform.

In some aspects, the semantic decoder is configured with a priori information, and wherein the semantic decoder is configured to decode the set of real values further based on the a priori information.

In some aspects, the semantic decoder is configured on a UE or a BS.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

### Example Communications Device

FIG. 10 depicts aspects of an example communications device 1000. In some aspects, communications device 1000 is a user equipment, such as UE 104 described above with respect to FIGS. 1 and 3. In some aspects, communications device 1000 is a network entity, such as BS 102 of FIGS. 1 and 3, or a disaggregated base station as discussed with respect to FIG. 2.

The communications device 1000 includes a processing system 1002 coupled to the transceiver 1038 (e.g., a transmitter and/or a receiver). In some aspects (e.g., when communications device 1000 is a network entity), processing system 1002 may be coupled to a network interface 1042 that is configured to obtain and send signals for the communications device 1000 via communication link(s), such as a backhaul link, midhaul link, and/or fronthaul link as described herein, such as with respect to FIG. 2. The transceiver 1038 is configured to transmit and receive signals for the communications device 1000 via the antenna 1040, such as the various signals as described herein. The processing system 1002 may be configured to perform processing functions for the communications device 1000, including processing signals received and/or to be transmitted by the communications device 1000.

The processing system 1002 includes one or more processors 1004. In various aspects, the one or more processors 1004 may be representative of one or more of receive processor 358, transmit processor 364, TX MIMO processor 366, and/or controller/processor 380, as described with respect to FIG. 3. In various aspects, one or more processors 1004 may be representative of one or more of receive processor 338, transmit processor 320, TX MIMO processor 330, and/or controller/processor 340, as described with respect to FIG. 3. The one or more processors 1004 are coupled to a computer-readable medium/memory 1020 via a bus 1036. In certain aspects, the computer-readable medium/memory 1020 is configured to store instructions (e.g., computer-executable code) that when executed by the one or more processors 1004, cause the one or more processors 1004 to perform the method 800 described with respect to FIG. 8, or any aspect related to it; and the method 900 described with respect to FIG. 9, or any aspect related to it. Note that reference to a processor performing a function of communications device 1000 may include one or more processors 1004 performing that function of communications device 1000.

In the depicted example, computer-readable medium/memory 1020 stores code (e.g., executable instructions), such as code for obtaining 1022, code for encoding 1024, code for outputting 1026, code for using 1028, code for generating 1030, code for decoding 1032, and code for attempting 1034. Processing of the code for obtaining 1022, code for encoding 1024, code for outputting 1026, code for using 1028, code for generating 1030, code for decoding 1032, and code for attempting 1034 may cause the communications device 1000 to perform the method 800 described with respect to FIG. 8, or any aspect related to it; and the method 900 described with respect to FIG. 9, or any aspect related to it.

The one or more processors 1004 include circuitry configured to implement (e.g., execute) the code stored in the computer-readable medium/memory 1020, including circuitry for obtaining 1006, circuitry for encoding 1008, circuitry for outputting 1010, circuitry for using 1012, circuitry for generating 1014, circuitry for decoding 1016, and circuitry for attempting 1018. Processing with circuitry for obtaining 1006, circuitry for encoding 1008, circuitry for outputting 1010, circuitry for using 1012, circuitry for generating 1014, circuitry for decoding 1016, and circuitry for attempting 1018 may cause the communications device 1000 to perform the method 800 described with respect to FIG. 8, or any aspect related to it; and the method 900 described with respect to FIG. 9, or any aspect related to it.

Various components of the communications device 1000 may provide means for performing the method 800 described with respect to FIG. 8, or any aspect related to it; and the method 900 described with respect to FIG. 9, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1038 and the antenna 1040 of the communications device 1000 in FIG. 10. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1038 and the antenna 1040 of the communications device 1000 in FIG. 10.

### Example Clauses

Implementation examples are described in the following numbered clauses:
Clause 1: A method for wireless communications, comprising: obtaining, by a semantic encoder, a set of real values for transmission to a receiving device; encoding, by the semantic encoder, the set of real values based on a semantic model and a first dimension of a set of dimensions, wherein each different dimension in the set of dimensions corresponds to a different number of real values to output; outputting an encoded set of real values; outputting the encoded set of real values for transmission to the receiving device over a wireless communication channel; obtaining feedback from the receiving device; and using a second dimension of the set of dimensions based on the feedback.
Clause 2: The method of Clause 1, wherein the semantic model is trained based on a model of the wireless communication channel abstracted as an AWGN channel on top of an existing PHY layer and a MAC layer.
Clause 3: The method of any one of Clauses 1 and 2, wherein the semantic model is trained based on one or more target specific perceptual loss values.
Clause 4: The method of Clause 3, wherein the target specific perceptual loss values are based on an application or a downstream task associated with the wireless communication, a configuration of the apparatus, a configuration of the receiving device, or a combination thereof.
Clause 5: The method of any combination of Clauses 1-4, wherein the semantic model is trained based on target specific training data.
Clause 6: The method of Clause 5, wherein the target specific training data is based on an application or a downstream task associated with the wireless communication, a configuration of the apparatus, a configuration of the receiving device, or a combination thereof.
Clause 7: The method of any combination of Clauses 1-6, wherein the semantic model for the semantic encoder is jointly trained with a semantic model for a semantic decoder at the receiving device.
Clause 8: The method of any combination of Clauses 1-7, wherein the semantic encoder comprises a neural network.
Clause 9: The method of any combination of Clauses 1-8, wherein the output encoded set of real values comprises an analog waveform.
Clause 10: The method of any combination of Clauses 1-9, further comprising: obtaining, by a source encoder, the encoded set of real values; and generating a set of coded symbols based on a third dimension, wherein: generating the set of coded symbols comprises mapping the encoded set of real values to a set of resource elements; and outputting the encoded set of real values for transmission to the receiving device over a wireless communication channel comprises outputting the set of coded symbols for transmission on the set of resource elements.
Clause 11: The method of any combination of Clauses 1-10, wherein the semantic encoder is configured with a priori information, and wherein the semantic encoder is configured to encode the set of real values further based on the a priori information.
Clause 12: The method of any combination of Clauses 1-11, wherein the semantic encoder is configured on a UE or a BS.
Clause 13: A method for wireless communications, comprising: obtaining, from a transmitting device, a first encoded set of real values having a first dimension of a set of dimensions, wherein each different dimension in the set of dimensions corresponds to a different number of real values of the set of real values; decoding, by a semantic decoder, the first encoded set of real values based on a semantic model; attempting to infer a set of real values; outputting feedback to the transmitting device; and obtaining, from the transmitting device, a second encoded set of real values having a second dimension of the set of dimensions in response to the feedback.
Clause 14: The method of Clause 13, wherein the semantic model is trained based on a model of the wireless communication channel abstracted as an AWGN channel on top of an existing PHY layer and a MAC layer.
Clause 15: The method of any combination of Clauses 13 and 14, wherein the semantic model is trained based on one or more target specific perceptual loss values.
Clause 16: The method of Clause 15, wherein the target specific perceptual loss values are based on an application or a downstream task associated with the wireless communication, a configuration of the apparatus, a configuration of the receiving device, or a combination thereof.
Clause 17: The method of any combination of Clauses 13-16, wherein the semantic model is trained based on target specific training data.
Clause 18: The method of Clause 17, wherein the target specific training data is based on an application or a downstream task associated with the wireless communication, a configuration of the apparatus, a configuration of the receiving device, or a combination thereof.
Clause 19: The method of any combination of Clauses 13-18, wherein the semantic model for the semantic decoder is jointly trained with a semantic model for a semantic encoder at the transmitting device.
Clause 20: The method of any combination of Clauses 13-19, wherein the semantic decoder comprises a neural network.
Clause 21: The method of any combination of Clauses 13-20, wherein the first encoded set of real values comprises an analog waveform.
Clause 22: The method of any combination of Clauses 13-21, wherein the semantic decoder is configured with a priori information, and wherein the semantic decoder is configured to decode the set of real values further based on the a priori information.
Clause 23: The method of any combination of Clauses 13-22, wherein the semantic decoder is configured on a UE or a BS.
Clause 24: An apparatus, comprising: a memory comprising executable instructions; and a processor configured to execute the executable instructions and cause the apparatus to perform a method in accordance with any one of Clauses 1-23.
Clause 25: An apparatus, comprising means for performing a method in accordance with any one of Clauses 1-23.
Clause 26: A non-transitory computer-readable medium comprising executable instructions that, when executed by a processor of an apparatus, cause the apparatus to perform a method in accordance with any one of Clauses 1-23.
Clause 27: A computer program product embodied on a computer-readable storage medium comprising code for performing a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiples of the same element (e.g., a−a, a−a−a, a−a−b, a−a−c, a−b−b, a−c−c, b−b, b−b−b, b−b−c, c−c, and c−c−c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications, comprising:
a semantic encoder configured to:
obtain a set of real values for transmission to a receiving device; and
encode the set of real values based on a semantic model and a first dimension of a set of dimensions, wherein each different dimension in the set of dimensions corresponds to a different number of real values to output; and
output an encoded set of real values;
a transmitter configured to output the encoded set of real values for transmission to the receiving device over a wireless communication channel; and
a receiver configured to obtain feedback from the receiving device, wherein the semantic encoder is further configured to use a second dimension of the set of dimensions based on the feedback.

2. The apparatus of claim 1, wherein the semantic model is trained based on a model of the wireless communication channel abstracted as an additive white Gaussian noise (AWGN) channel on top of an existing physical (PHY) layer and a medium access control (MAC) layer.

3. The apparatus of claim 1, wherein the semantic model is trained based on one or more target specific perceptual loss values.

4. The apparatus of claim 3, wherein the target specific perceptual loss values are based on an application or a downstream task associated with the wireless communication, a configuration of the apparatus, a configuration of the receiving device, or a combination thereof.

5. The apparatus of claim 1, wherein the semantic model is trained based on target specific training data.

6. The apparatus of claim 5, wherein the target specific training data is based on an application or a downstream task associated with the wireless communication, a configuration of the apparatus, a configuration of the receiving device, or a combination thereof.

7. The apparatus of claim 1, wherein the semantic model for the semantic encoder is jointly trained with a semantic model for a semantic decoder at the receiving device.

8. The apparatus of claim 1, wherein the semantic encoder comprises a neural network.

9. The apparatus of claim 1, wherein the output encoded set of real values comprises an analog waveform.

10. The apparatus of claim 1, further comprising a source encoder configured to:
obtain the encoded set of real values; and
generate a set of coded symbols based on a third dimension, wherein:
the source encoder being configured to generate the set of coded symbols comprises the source encoder being configured to map the encoded set of real values to a set of resource elements; and
the transmitter being configured to output the encoded set of real values for transmission to the receiving device over a wireless communication channel comprises the transmitter being configured to output the set of coded symbols for transmission on the set of resource elements.

11. The apparatus of claim 1, wherein the semantic encoder is configured with a priori information, and wherein the semantic encoder is configured to encode the set of real values further based on the a priori information.

12. The apparatus of claim 1, wherein the apparatus comprises a user equipment (UE) or a base station (BS).

13. An apparatus for wireless communications, comprising:
a receiver configured to:
receive, from a transmitting device, a first encoded set of real values having a first dimension of a set of dimensions, wherein each different dimension in the set of dimensions corresponds to a different number of real values of the set of real values;
a semantic decoder configured to:
decode the first encoded set of real values based on a semantic model; and
attempt to infer a set of real values; and
a transmitter configured to output feedback to the transmitting device, wherein the semantic decoder is further configured to receive, from the transmitting device, a second encoded set of real values having a second dimension of the set of dimensions in response to the feedback.

14. The apparatus of claim 13, wherein the semantic model is trained based on a model of a wireless communication channel abstracted as an additive white Gaussian noise (AWGN) channel on top of an existing physical (PHY) layer and a medium access control (MAC) layer.

15. The apparatus of claim 13, wherein the semantic model is trained based on one or more target specific perceptual loss values.

16. The apparatus of claim 15, wherein the target specific perceptual loss values are based on an application or a downstream task associated with the wireless communication, a configuration of the apparatus, a configuration of a receiving device, or a combination thereof.

17. The apparatus of claim 13, wherein the semantic model is trained based on target specific training data.

18. The apparatus of claim 17, wherein the target specific training data is based on an application or a downstream task associated with the wireless communication, a configuration of the apparatus, a configuration of a receiving device, or a combination thereof.

19. The apparatus of claim 13, wherein the semantic model for the semantic decoder is jointly trained with a semantic model for a semantic encoder at the transmitting device.

20. The apparatus of claim 13, wherein the semantic decoder comprises a neural network.

21. The apparatus of claim 13, wherein the first encoded set of real values comprises an analog waveform.

22. The apparatus of claim 13, wherein the semantic decoder is configured with a priori information, and wherein the semantic decoder is configured to decode the set of real values further based on the a priori information.

23. The apparatus of claim 13, wherein the apparatus comprises a user equipment (UE) or a base station (BS).

24. A method for wireless communications, comprising:
obtaining, by a semantic encoder, a set of real values for transmission to a receiving device;
encoding, by the semantic encoder, the set of real values based on a semantic model and a first dimension of a set of dimensions, wherein each different dimension in the set of dimensions corresponds to a different number of real values to output;
outputting an encoded set of real values;
outputting the encoded set of real values for transmission to the receiving device over a wireless communication channel;
obtaining feedback from the receiving device; and
using a second dimension of the set of dimensions based on the feedback.

25. The method of claim 24, wherein the semantic model is trained based on a model of the wireless communication channel abstracted as an additive white Gaussian noise (AWGN) channel on top of an existing physical (PHY) layer and a medium access control (MAC) layer.

26. The method of claim 24, wherein the semantic model is trained based on one or more target specific perceptual loss values.

27. The method of claim 26, wherein the target specific perceptual loss values are based on an application or a downstream task associated with the wireless communication, a configuration of a transmitting device, a configuration of the receiving device, or a combination thereof.

28. The method of claim 24, wherein the semantic model is trained based on target specific training data.

29. The method of claim 28, wherein the target specific training data is based on an application or a downstream task associated with the wireless communication, a configuration of a transmitting device, a configuration of the receiving device, or a combination thereof.

30. A method for wireless communications, comprising:
obtaining, from a transmitting device, a first encoded set of real values having a first dimension of a set of dimensions, wherein each different dimension in the set of dimensions corresponds to a different number of real values of the set of real values;
decoding, by a semantic decoder, the first encoded set of real values based on a semantic model;
attempting to infer a set of real values;
outputting feedback to the transmitting device; and
obtaining, from the transmitting device, a second encoded set of real values having a second dimension of the set of dimensions in response to the feedback.
